(19) United States
(12) Patent Application Publication
(10) Pub. No.: US 2024/0266637 A1
(43) Pub. Date: Aug. 8, 2024

(54) VEHICLE BATTERY COOLING DEVICE

(71) Applicant: TOYOTA JIDOSHA KABUSHIKI KAISHA, Toyota-shi Aichi-ken (JP)

(72) Inventors: Shiho HIROKAWA, Toyota-shi Aichi-ken (JP); Hirotaka SASAKI, Nagoya-shi Aichi-ken (JP)

(73) Assignee: TOYOTA JIDOSHA KABUSHIKI KAISHA, Toyota-shi Aichi-ken (JP)

(21) Appl. No.: 18/430,775

(22) Filed: Feb. 2, 2024

(30) Foreign Application Priority Data
Feb. 7, 2023 (JP) 2023-016636

(51) Int. Cl. H01M 10/6564; H01M 10/613; H01M 10/625

(52) U.S. Cl. CPC H01M 10/6564; H01M 10/613; H01M 10/625; H01M 2220/20

(57) ABSTRACT

The battery cooling device that cools a battery by circulating a refrigerant by a compressor and cools air blown into a vehicle compartment, and when the battery is being rapidly charged, the rotation speed of the compressor is increased. More specifically, the upper limit rotation speed of the compressor is increased to a predetermined rotation speed. At this time, the predetermined number of revolutions is determined based on a maximum allowable noise level at the time of rapid charge of the battery.

### CROSS REFERENCE TO RELATED APPLICATION

This application claims priority to Japanese Patent Application No. 2023-016636 filed on Feb. 7, 2023, which is incorporated herein by reference in its entirety including the specification, claims, drawings, and abstract.

### TECHNICAL FIELD

The present disclosure relates to a vehicle battery cooling device for controlling during rapid charging of a battery.

### BACKGROUND

A traveling battery mounted on a vehicle generates heat by charging and discharging, and battery characteristics such as discharge characteristics are degraded due to temperature rise due to heat generation. Therefore, the battery is cooled so that the temperature of the battery does not rise too much. In particular, when the travel battery mounted on a vehicle is rapidly charged, it is necessary to sufficiently cool the battery. For example, JP2007-336691 discloses a technology for increasing the cooling capability of a battery by increasing the rotation speed of a cooling fan of the battery during rapid charging.

### SUMMARY

The vehicle battery cooling device may cool the battery by circulating the refrigerant by the compressor. In this device, the cooling capacity can be increased by increasing the rotation speed of the compressor. Therefore, in this device, there is room for reducing the rapid charge time by increasing the cooling capacity of the battery during rapid charge.

Accordingly, an object of the present disclosure is to provide a vehicle battery cooling device capable of shortening the rapid charge time.

A vehicle battery cooling device according to the present disclosure cools a battery by circulating a refrigerant by a compressor and cools air supplied into a vehicle compartment, wherein when the battery is being rapidly charged, rotation speed of the compressor is increased.

According to the above configuration, it is possible to increase the cooling capability of the battery during rapid charging and shorten the rapid charging time.

In some embodiments of the vehicle battery cooling device according to the present disclosure, the upper limit rotation speed of the compressor is increased when the battery is being rapidly charged.

In some embodiments of the vehicle battery cooling device according to the present disclosure, when the battery is rapidly charged and the cooled air is blown into the vehicle compartment, a target supply temperature for the cooled air blown into the vehicle compartment is raised.

According to the above configuration, since the cooling capability of the air conditioner decreases, the cooling capability of the battery increases, and the rapid charge time can be shortened.

In some embodiments of the vehicle battery cooling device according to the present disclosure, the increase in the upper limit rotation speed is determined based on a maximum allowable noise level during rapid charging of the battery.

According to the above configuration, even when the rotation speed of the compressor is increased, the maximum allowable noise level at the time of rapid charge of the battery is not exceeded.

According to the vehicle battery cooling device of the present disclosure, it is possible to shorten the rapid charge time of the battery.

### BRIEF DESCRIPTION OF DRAWINGS

FIG. 1 is a schematic view showing a vehicle according to an embodiment.

FIG. 2 is a circuit diagram showing a battery cooling device according to an embodiment.

FIG. 3 is a block diagram showing a configuration of a control unit.

FIG. 4 is a flowchart showing a flow of battery cooling control.

### DESCRIPTION OF EMBODIMENTS

Hereinafter, an example of an embodiment of the present disclosure will be described in detail. In the following description, specific shapes, materials, directions, numerical values, and the like are examples for facilitating understanding of the present disclosure, and can be appropriately changed in accordance with applications, purposes, specifications, and the like.

A battery cooling device 10 as a vehicle battery cooling device cools a traveling battery 20 by circulating a refrigerant by a compressor 11, and cools air blown into the vehicle compartment 6. According to the battery cooling device 10, the rapid charge time of the battery 20 can be shortened, as will be described later in detail.

### Vehicles

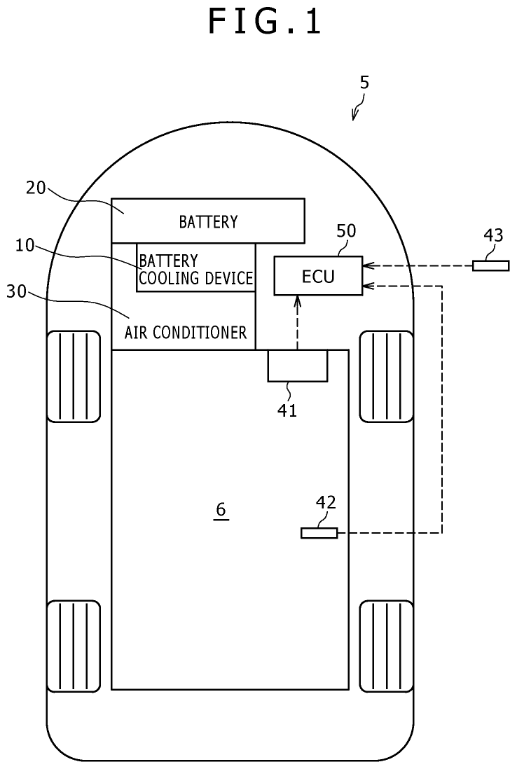

A vehicle 5 according to an embodiment will be described with reference to FIG. 1.

As shown in FIG. 1, a battery cooling device 10 as a vehicle battery cooling device is provided in a vehicle 5. The vehicle 5 includes a battery cooling device 10, the traveling battery 20, an air conditioner 30 for conditioning air in the vehicle compartment 6, and ECU 50 (Electronic Control Unit) serving as a control unit for controlling each device of the battery cooling device 10 and the air conditioner 30.

The vehicle 5 is an electric vehicle that runs using a motor as power, but may be, for example, a hybrid vehicle that runs using an engine and a motor as power.

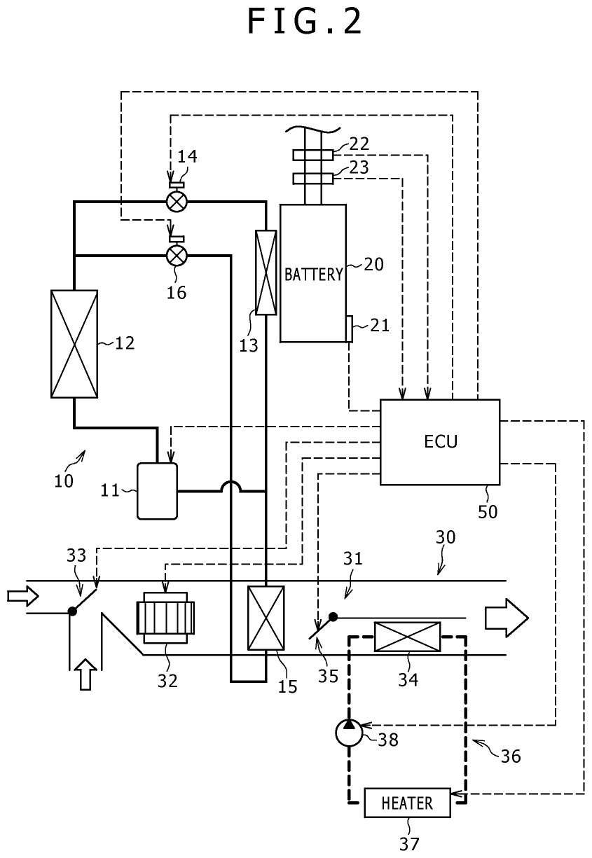

In some embodiments, a rechargeable secondary battery is used as the battery 20. The battery 20 can be rapidly charged by a direct current by a dedicated quick charger. The battery 20 is provided with a battery temperature sensor 21 for detecting a temperature of the battery 20, a battery voltage sensor 22 for detecting a voltage of the battery 20, and a battery current sensor 23 for detecting a current related to charge and discharge of the battery 20 (see FIG. 2).

### Battery Cooling Device

The battery cooling device 10 and the air conditioner 30, which are examples of the embodiment, will be described with reference to FIG. 2. The battery cooling device 10 circulates the refrigerant by a vapor compression refrigeration cycle, cools the battery 20 by circulating the refrigerant in the battery cooler 13, and cools the air blown into the vehicle compartment 6 by circulating the refrigerant in the evaporator 15 of the air conditioner 30, which will be described later. The battery cooling device 10 includes a compressor 11 that compresses a refrigerant gas, a condenser 12 that condenses a high-temperature and high-pressure refrigerant gas discharged from the compressor 11, a battery cooler 13 that cools the battery 20, a first expansion valve 14 that adjusts the circulation amount of the refrigerant in the battery cooler 13, an evaporator 15 that cools the air blown into the vehicle compartment 6 in the air conditioner 30, and a second expansion valve 16 that adjusts the circulation amount of the refrigerant in the evaporator 15.

The compressor 11 is driven by an electric motor (not shown), and by changing the frequency of the electric motor, the rotation speed can be changed to change the output.

The air conditioner 30 includes an air passage 31 through which air for cooling and/or heating air blown into the vehicle compartment 6 passes, and a heating circuit 36 for heating air supplied to the vehicle compartment 6. Further, the air conditioner 30 includes an operation unit 41 capable of changing the set temperature of the vehicle interior 6, an internal air temperature sensor 42 for detecting the temperature of the vehicle interior 6, and an outside air temperature sensor 43 for detecting the outside air temperature of the vehicle 5 (see FIG. 1).

The air conditioner 30 further includes a blower 32, an inside/outside air switching door 33, an evaporator 15, a heater core 34, and an air mix door 35. The blower 32 generates an air flow toward the vehicle compartment 6 in the air passage 31. The inside/outside air switching door 33 switches the introduction of air (inside air) in the vehicle compartment 6 or the introduction of air (outside air) outside the vehicle 5. The evaporator 15 is provided in the battery cooling device 10 and cools the air passing through the air passage 31. The heater core 34 is connected to the heating circuit 36 and heats the air passing through the air passage 31. The air mix door 35 opens and closes an air passage 31 passing through the heater core 34.

The heating circuit 36 is a circuit that circulates water heated by the heater 37 as a heat source to heat air passing through the air passage 31 by the heater core 34. The heating circuit 36 has an output adjustable, and includes a heater 37 for heating water circulating in the heating circuit 36, a heater core 34 provided in the air passage 31 as described above for heating air passing through the air passage 31, and a pump 38 for circulating water in the heating circuit 36.

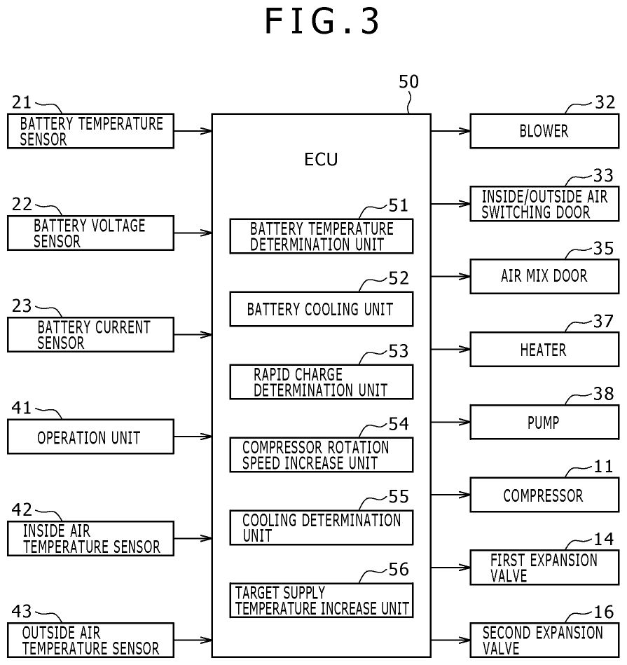

Referring to FIGS. 2 and 3, an ECU 50 as a control unit will be described.

As shown in FIGS. 2 and 3, the ECU 50 as a control unit controls each device of the battery cooling device 10 and the air conditioner 30, as described above. The ECU 50 includes a CPU (Central Processing Unit) serving as an arithmetic processing unit, a storage unit such as a RAM (Random Access Memory) and a ROM (Read Only Memory), and performs signal processing according to a program stored in advance in the ROM while using a temporary storage function of the RAM.

In the present embodiment, the ECU 50 controls each device of the battery cooling device 10 and the air conditioner 30. The ECU for controlling each device of the battery cooling device 10 and the ECU for controlling each device of the air conditioner 30 may be different ECUs.

The ECU 50 is connected to the compressor 11, the first expansion valve 14, the second expansion valve 16, the blower 32, the inside/outside air switching door 33, the air mix door 35, the heater 37, and the pump 38, and transmits signals to them. The ECU 50 is connected to the battery temperature sensor 21, the battery voltage sensor 22, and the battery current sensor 23 and receives signals from the battery temperature sensor 21, the battery voltage sensor 22, and the battery current sensor 23. Further, the ECU 50 is connected to the operation unit 41, the inside air temperature sensor 42, and the outside air temperature sensor 43 and receives signals from them.

The ECU 50 includes a battery temperature determination unit 51, a battery cooling unit 52, a rapid charge determination unit 53, a compressor rotation speed increase unit 54, a cooling determination unit 55, and a target supply temperature increase unit 56. The battery temperature determination unit 51, the battery cooling unit 52, the rapid charge determination unit 53, the compressor rotation speed increase unit 54, the cooling determination unit 55, and the target supply temperature increase unit 56 are implemented by the CPU executing a program stored in the ROM or the RAM.

The battery temperature determination unit 51 determines whether or not the battery temperature detected by the battery temperature sensor 21 is equal to or higher than a predetermined temperature. In some embodiments, the predetermined temperature is determined based on a temperature at which battery characteristics such as discharge characteristics are degraded.

The battery cooling section 52 cools the battery 20 by the battery cooler 13 when the battery temperature is equal to or higher than a predetermined temperature. More specifically, the refrigerant is circulated in the battery cooler 13 by operating the compressor 11, and the refrigerant circulation amount of the battery cooler 13 is adjusted by the first expansion valve 14. The rotation speed of the compressor 11 and the opening degree of the first expansion valve 14 may be adjusted by the battery temperature. According to the battery cooling section 52, it is possible to avoid a decrease in battery characteristics such as discharge characteristics of the battery 20.

The rapid charge determination unit 53 determines whether or not the charge is rapid charge based on the current and voltage at the time of charge of the battery 20 detected by the battery voltage sensor 22 and the battery current sensor 23. When separate connectors are used, rapid charging and ordinary charging may be determined based on the connectors (charging circuits) used.

When the battery 20 is cooled during rapid charging of the battery 20, the compressor rotation speed increasing unit 54 increases the rotation speed of the compressor 11 of the battery cooling device 10. More specifically, the upper limit rotation speed of the compressor 11 is increased to a predetermined rotation speed to enable the compressor 11 to operate to a predetermined rotation speed. As a result, when the battery temperature rises, the rotation speed of the compressor 11 can rise to a predetermined rotation speed, and the cooling capability of the battery cooling device 10 can be increased during rapid charging to shorten the rapid charging time.

In the compressor rotation speed increasing section 54, the predetermined rotation speed is determined based on the maximum allowable noise level at the time of rapid charge of the battery 20. More specifically, the predetermined number of revolutions is determined such that the noise level due to the number of revolutions of the predetermined number of revolutions is equal to or lower than the maximum allowable noise level at the time of rapid charge of the battery 20. The maximum allowable noise level at the time of rapid charging is the maximum allowable level of the noise level generated from the rapid charger and the vehicle 5 at the time of rapid charging of the battery 20 of the vehicle 5.

Thus, even when the rotation speed of the compressor 11 is increased during rapid charging, it is possible to avoid exceeding the maximum allowable noise level at the time of rapid charging of the battery 20. In other words, by increasing the rotation speed of the compressor 11 to the maximum allowable noise level at the time of rapid charging of the battery 20, the cooling capability of the battery cooling device 10 can be increased during rapid charging to shorten the rapid charging time.

In the present embodiment, the upper limit rotation speed of the compressor 11 is increased to a predetermined rotation speed. However, the present disclosure is not limited thereto. For example, the current rotation speed of the compressor 11 may be increased by a predetermined rotation speed width, or the current rotation speed of the compressor 11 may be increased to a predetermined rotation speed.

The cooling determination unit 55 determines whether or not the air conditioner 30 is performing the cooling operation. In other words, the cooling determination unit 55 determines whether or not the battery cooling device 10 cools the air supplied to the vehicle interior 6. Specifically, the cooling determination unit 55 may determine whether or not the refrigerant circulates in the evaporator 15 by the opening degree of the second expansion valve 16.

The cooling operation is executed when the inside air temperature in the vehicle compartment 6 detected by the inside air temperature sensor 42 is higher than the target supply temperature. The target supply temperature is a target temperature of air supplied from the blowout port of the air passage 31 into the vehicle interior 6 based on the set temperature of the vehicle interior 6 set by the operation unit 41, the inside air temperature of the vehicle interior 6 detected by the inside air temperature sensor 42, and the outside air temperature of the vehicle 5 detected by the outside air temperature sensor 43.

In the cooling operation, the refrigerant is circulated in the evaporator 15 by operating the compressor 11, the refrigerant circulation amount of the evaporator 15 is adjusted by the second expansion valve 16, and the air passing through the air passage 31 is cooled by the evaporator 15. The rotation speed of the compressor 11 and the opening degree of the second expansion valve 16 may be adjusted by the target supply temperature.

The target supply temperature increasing unit 56 increases the target supply temperature by a predetermined temperature when the battery 20 is rapidly charged and the air conditioner 30 is in the cooling operation. Thereby, the refrigerant circulation amount of the evaporator 15 decreases, and the refrigerant circulation amount of the battery cooler 13 increases. As a result, the cooling capability of the battery 20 increases, and the rapid charge time can be shortened.

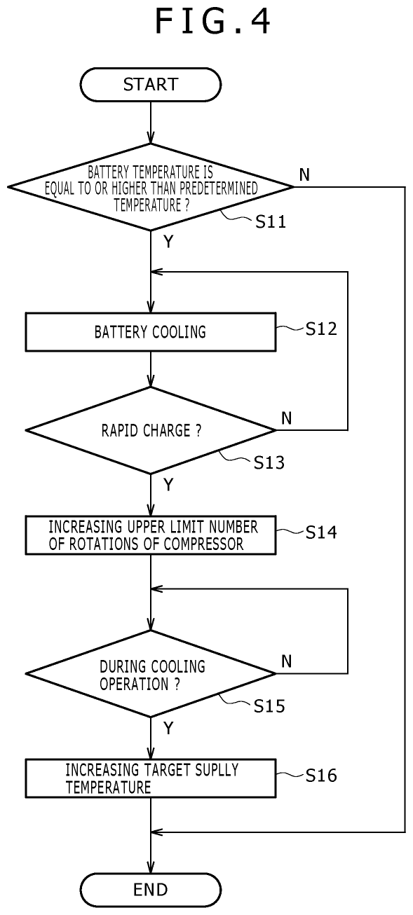

The flow of the battery cooling control will be described with reference to FIG. 4.

In the battery cooling control, the battery cooling device 10 cools the battery 20 based on each function of the ECU 50 described above in accordance with the following procedure. In step S11, the battery temperature determination unit 51 determines whether or not the battery temperature detected by the battery temperature sensor 21 is equal to or higher than a predetermined temperature. When the battery temperature is equal to or higher than the predetermined temperature, the process proceeds to step S12.

In step S12, the battery cooling unit 52 cools the battery 20. More specifically, the refrigerant is circulated in the battery cooler 13 by operating the compressor 11, and the refrigerant circulation amount of the battery cooler 13 is adjusted by the first expansion valve 14. The rotation speed of the compressor 11 and the opening degree of the first expansion valve 14 may be adjusted by the battery temperature.

In step S13, the rapid charge determination unit 53 determines whether or not the charge is rapid charge based on the current and voltage at the time of charge of the battery 20 detected by the battery voltage sensor 22 and the battery current sensor 23. In the case of rapid charging, the process proceeds to step S14.

In step S14, the compressor rotation speed increasing unit 54 increases the upper limit rotation speed of the compressor 11 of the battery cooling device 10 to a predetermined rotation speed to enable the compressor 11 to operate to a predetermined rotation speed. The predetermined number of revolutions is determined based on the maximum allowable noise level when the battery 20 is rapidly charged. More specifically, the predetermined number of revolutions is determined such that the noise level due to the number of revolutions of the predetermined number of revolutions is equal to the maximum allowable noise level at the time of rapid charge of the battery 20.

In step S15, the cooling determination unit 55 determines whether or not the air conditioner 30 is performing the cooling operation. When the cooling operation is being performed, the process proceeds to step S16. In step S16, the target supply temperature increasing unit 56 increases the target supply temperature by a predetermined temperature.

It should be noted that the present disclosure is not limited to the above-described embodiments and modifications thereof, and it is needless to say that various changes and modifications can be made without departing from the scope of the claims of the present application.

In the battery cooling device 10 of the present embodiment, the battery 20 is cooled by circulating the refrigerant in the battery cooler 13. However, the present disclosure is not limited thereto. The present disclosure may have a configuration in which a cooling medium is circulated in a heat exchanger with cooling water by a battery cooling device to cool the cooling water, and the battery 20 is cooled by the cooling water.

1. A vehicle battery cooling device that cools a battery by circulating a refrigerant by a compressor and cools air blown into a vehicle compartment, wherein
when the battery is being rapidly charged, a rotation speed of the compressor is increased.

2. The vehicle battery cooling device according to claim 1, wherein when the battery is being rapidly charged, an upper limit rotation speed of the compressor is increased.

3. The vehicle battery cooling device according to claim 2, wherein when the battery is rapidly charged and cooled air is supplied into the vehicle compartment, a target supply temperature for the cooled air blown into the vehicle compartment is increased.

4. The vehicle battery cooling device according to claim 2, wherein the increase in the upper limit rotation speed is determined based on a maximum allowable noise level during rapid charging of the battery.

5. The vehicle battery cooling device according to claim 3, wherein the increase in the upper limit rotation speed is determined based on a maximum allowable noise level during rapid charging of the battery.
